(19) United States
(12) Patent Application Publication
(10) Pub. No.: US 2006/0255938 A1
(43) Pub. Date: Nov. 16, 2006

(54) Saftey provisions for surgical tools and mri

(76) Inventor: Johan S. Van den Brink, Deil (NL)

Correspondence Address: PHILIPS INTELLECTUAL PROPERTY & STANDARDS, 595 MINER ROAD, CLEVELAND, OH, 44143, US

(21) Appl. No.: 10/569,192

(22) PCT Filed: Aug. 9, 2004
(86) PCT No.: PCT/IB04/02632

§ 371 Date: Feb. 22, 2006

(51) Int. Cl. G08B 13/14

(52) U.S. Cl. 340/568.1

(57) ABSTRACT

A subject on a pallet (22) undergoes a surgical procedure in the vicinity of an MR scanner using non-MRI compatible instruments (40) from a tray (42). The procedure may, for example, insert a catheter which is MRI compatible. After the procedure, the pallet (22) is transferred by a transfer gurney (26′) or a drive (122) and moved across a 5 Gauss line (32) and into an imaging region (30) of an MRI scanner (12). To be sure that none of the non-MRI compatible instruments crosses the 5 Gauss line (32), a circuit (50) senses whether all of the instruments have been repositioned at their preselected locations in the tray (42). The circuit (50) controls one of a light (60) which indicates whether or not it is safe to cross the 5 Gauss line, prevents brakes on the movable transport gantry (26) from being released, prevents a pallet manipulating mechanism (24) from transferring the pallet to the transport gantry, or prevents the transport gantry from being released from its docking position with the manipulating mechanism (24).

The present invention relates to the medical arts, particularly to diagnostic imaging and surgical procedures.

Frequently, interventional and therapy suites include both a magnetic resonance imaging system and an x-ray imaging system. In an exemplary interventional surgical procedure, an MRI catheter is inserted and coarsely positioned at the x-ray imager with the assistance of surgical tools such as needles, scissors, and knives, which are not magnetic resonance compatible. Specifically, the instruments may include ferrous materials which could be levitated by the fringe magnetic fields of the magnetic resonance system and propelled towards its isocenter if the tools were moved within the 5 Gauss line of the scanner. Such levitated and propelled tools risk injury to the patient and associated personnel. Even tools with too little ferrous material to pose a safety risk can still degrade the resultant images.

To assure that no tools are inadvertently transported within the 5 Gauss region, the surgical tools are mounted on a board in a clearly visible location within the x-ray side of the suite, e.g., on the wall. In addition to a cardiologist or two, an x-ray operator, an ordinary nurse, and an anesthetist, a safety nurse is often present in the suite. One of the safety nurse's primary functions is to observe the board to be sure that every instrument has been returned to the board before the patent is transported from the x-ray side to the MRI side of the suite.

With trauma victims and some other types of patients, time is of the essence. The surgeons and other personnel in the room may be hurrying to complete the surgical procedure. Moreover, with about a half dozen people in the room, there can be miscommunications, and the like.

The current procedure is based on human observation and is thus subject to human error. Moreover, the addition of a safety nurse to the surgical team adds cost and expense.

The present invention overcomes the above-referenced problems and others.

In accordance with one aspect of the present invention, an apparatus is provided for inhibiting surgical tools from being brought into proximity with a magnetic resonance scanner. A sensing means senses whether each of a plurality of surgical instruments has been positioned at a preselected location. A means connected with the individual instrument determines whether all of the instruments have been returned to their preselected locations and issues a signal which indicates whether or not all of the instruments have been returned.

In accordance with another aspect of the present invention, a method of inhibiting surgical tools from being brought into proximity with a magnetic resonance scanner is provided. A determination is made whether each of a set of medical instruments has been returned to a preselected location. A determination is then made whether all of the medical instruments of the set have been returned to the preselected location. If, and only if, this condition is met, the patient support is allowed to move into the magnetic field exposed area.

One advantage of the present invention is that it reduces the potential for ferrous surgical tools to move into the field of an MRI scanner.

Another advantage of the present invention is that it reduces a possibility of human error.

Another advantage is that it alleviates the need to acquire a full set of MR compatible surgical tools, and to keep track of MR compatible and non-compatible tools in the sterilization unit.

Yet another advantage resides in potentially reduced labor costs.

Still further advantages and benefits of the present invention will become apparent to those of ordinary skill in the art upon reading and understanding the following detailed description of the preferred embodiments.

The invention may take form in various components and arrangements of components, and in various steps and arrangements of steps. The drawings are only for purposes of illustrating the preferred embodiments and are not be construed as limiting the invention.

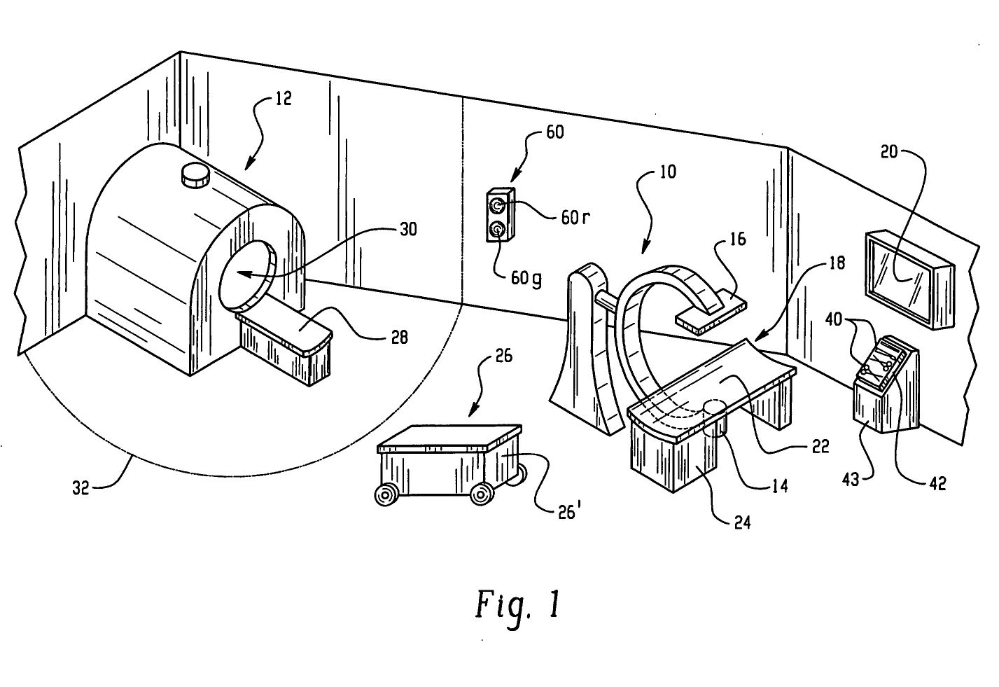

FIG. 1 is a diagrammatic illustration of a surgical suite outfitted in accordance with the present invention;

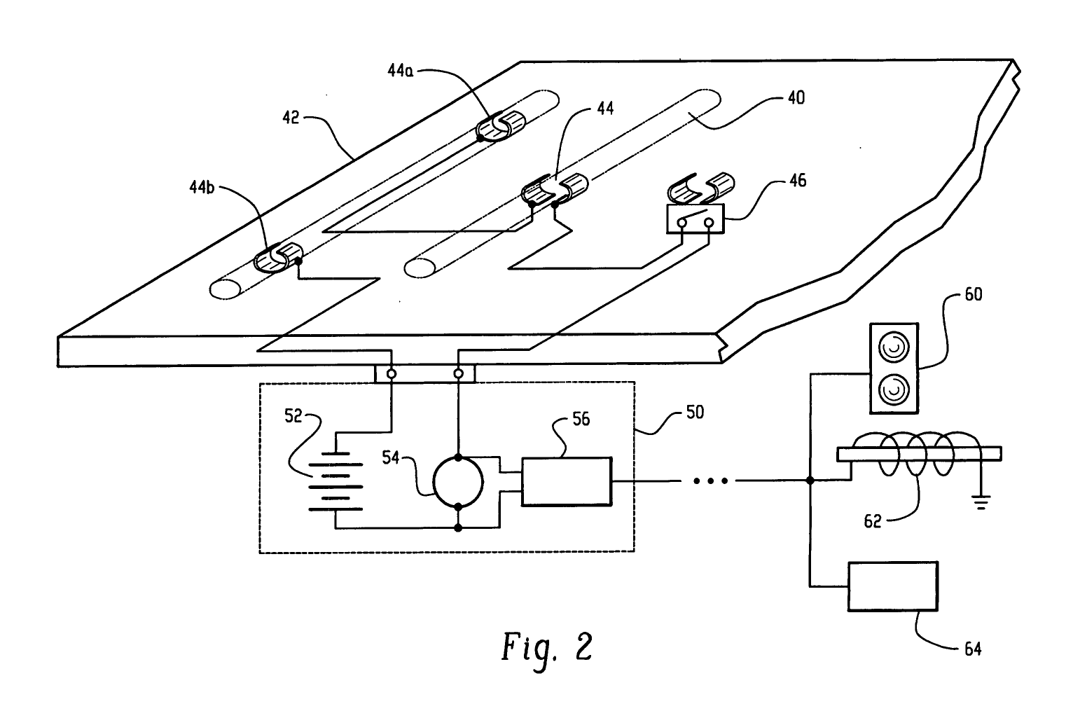

FIG. 2 is a diagrammatic illustration of a preferred embodiment of an electrical system for sensing whether instruments have been returned to their tray;

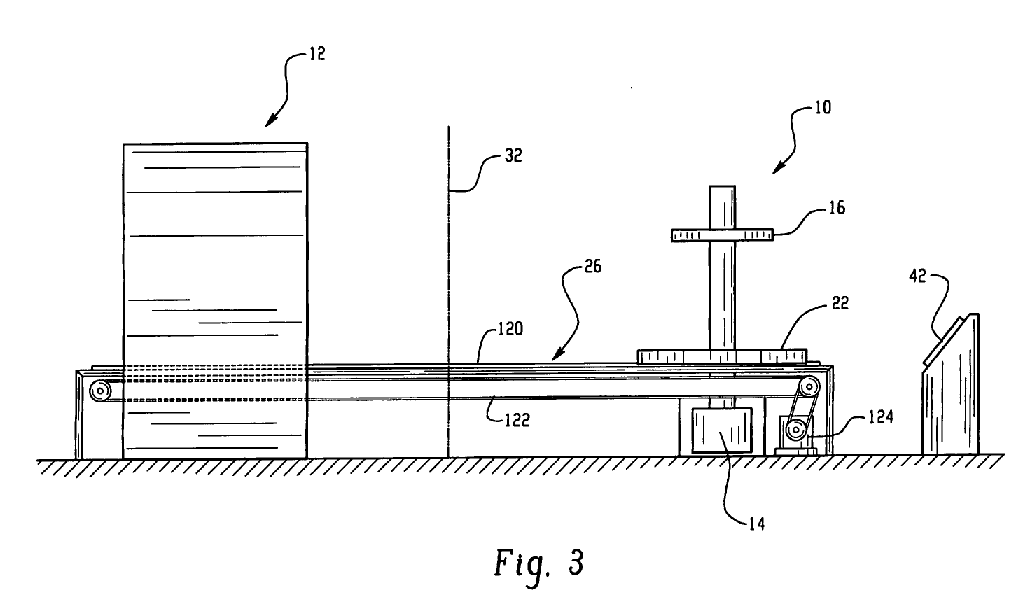

FIG. 3 illustrates an optical sensing system for sensing whether instruments have been returned to the tray;

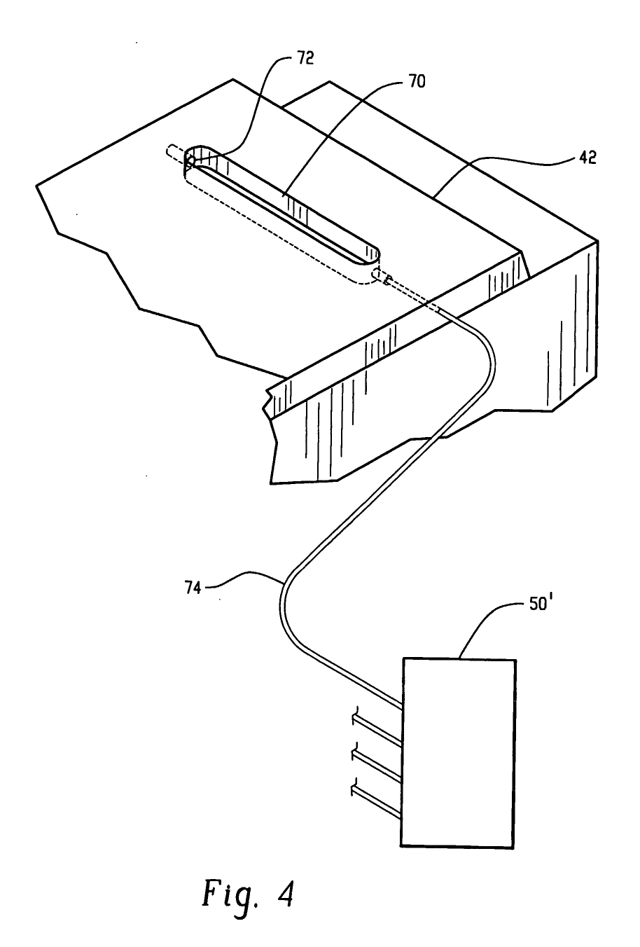

FIG. 4 illustrates another mechanism for transferring the pallet between the x-ray and MRI images.

With reference to FIG. 1, a surgical suite houses an x-ray imaging device 10 and a magnetic resonance imaging (MRI) device or scanner 12. In the illustrated embodiment, the x-ray imaging device is a C-arm scanner including an x-ray tube 14 and a device 16 for converting x-rays that have passed through a patient support 18 into corresponding electronic signals. Suitable devices include flat direct x-ray to electrical signal conversion panels, an image intensifier with a video camera, or the like. The x-ray converting device 16 is connected with a video monitor 20 to enable a surgeon operating on a patient on the patient support 18 to view one or more x-ray images. The x-ray tube is preferably operable in either a radiographic mode or a fluoroscopic mode. Although a C-arm x-ray scanner is illustrated, CT scanners, ultrasound, and other types of non-magnetic scanners are also contemplated.

The patient support 18 includes a pallet 22 on which the patient is supported and a mechanism 24 for positioning the pallet in an imaging region defined between the x-ray source and the x-ray detector. The x-ray positioning mechanism 24 can raise and lower the pallet, advance the pallet longitudinally, and can feed the pallet from the support mechanism 24 onto a pallet transfer means 26 a transport gurney or trolley 26′.

The transport gurney is docked at the end of the support mechanism 24 with wheel locks locked to receive the pallet 22. Electrical and mechanical interlocks are engaged before the pallet is transferred to prevent undocking until the pallet transfer is complete. Once the pallet has been transferred, the transport gurney can be released from the mechanism 24, its wheel locks can be released. The transport gurney 26′ wheels the patient and the pallet to the MRI scanner 12. At the MRI scanner, the transport gurney 26′ is docked to an MRI pallet handling mechanism 28. Once the gurney has been docked to the mechanism and its wheels locked, an automatic drive in the MRI pallet handling mechanism 28 moves the patient pallet 22 from the gurney into the imaging region, such as a bore 30, of the MRI scanner.

The magnetic resonance scanner typically has relatively high magnetic fields (1.5 T-3.0 T) within the bore 30 where the imaging region is defined. Particularly, with superconducting magnets, the MRI scanner is always “at field”. That is, there is always a high magnetic field in the bore. Further, although the magnetic resonance scanner is shielded, there are stray magnetic fields around the scanner. Typically, a 5 Gauss line 32 is marked on the floor of the suite, delineated by ropes, or otherwise denoted. The 5 Gauss line marks the region inside of which the stray magnetic fields exceed 5 Gauss. This area typically surrounds the magnet by 1.5 to 2.5 meters. Current safety standards mandate that ferrous objects and tools which are not MRI compatible must remain beyond the 5 Gauss line. Of course, safety lines at other stray field strengths are also contemplated, particularly if safety standards change.

When a surgical operation is performed at the x-ray scanner or on the transport gurney, surgical instruments 40 are typically mounted in a tray 42. The tray 42 is configured to receive a set of instruments which are selected as being the instruments which are commonly used with a given surgical procedure. Before the procedure, the tray with a fresh set of sterilized instruments is mounted to a support 43 where it is clearly observable to, and easily accessible for the surgeons, nurses, and other attendants in the surgical suite. The tray may be mounted to a wall of the suite, to a stand disposed near the x-ray scanner, or the like.

With continuing reference to FIG. 1 and further reference to FIG. 2, the tray 42 has regions for receiving each of the surgical instruments. These regions may be denoted by drawings or labeling on the tray, recesses shaped to match the instruments in the tray, or the like. In a first embodiment, the tray includes metal clips 44 which are sized and dimensioned to grasp the corresponding surgical instrument resiliently. In one embodiment of the clips, the instrument acts as an electrical conductor between a pair of clips 44a, 44b. In another embodiment, the surgical instrument acts as a conductor between halves of a single clip 44. In yet another embodiment, as the halves or elements are moved apart to receive the instruments, the elements close an associated electrical switch 46. In the illustrated embodiment of FIG. 2, the circuit segments between the clips are connected in series. A plug and socket arrangement 48 between the tray and the support structure interconnects each tray of fresh instruments that is positioned on the support structure with electrical circuitry or means 50 for determining whether all of the surgical instruments are in place. In the illustrated embodiment, the circuit 50 includes a very low voltage and current power supply 52 and an ammeter or circuit device 54 for sensing whether current is flowing through the current loop through the instruments. Rather than an ammeter, the circuit device 54 includes a resister, with a voltage level comparator 56 connected across it. If the voltage across the resistor is zero, the circuit is open and a surgical instrument is missing. If there is a preselected voltage across the resistor, then the compare circuit 56 sends out a signal indicating that all instruments have been stowed.

Various other means for sensing whether all of the instruments have been returned to the tray are also contemplated. For example, the circuit can connect inductively or capacitively with each instrument. The presence of each surgical instrument can alter the frequency of an LC oscillator circuit. Switches 46 can be connected in parallel rather than series and be biased to be closed when instruments are absent and open in the presence of an instrument. The comparator 56 then determines when there is no current flow to issue the signal indicating that all instruments are stowed. Proximity sensors, magnetic sensors, optical sensors, and others can also be utilized.

In one embodiment, the signal which indicates that all instruments have been returned to their tray causes a light 60 to indicate that it is safe to move the patient pallet across the 5 Gauss line. In the illustrated embodiment, the light 60 is positioned near the 5 Gauss line, and includes a red lamp 60r which remains lit whenever a surgical instrument is out of the tray and a green light 60g which turns on as the red light turns off when all of the surgical instruments have been returned. In another embodiment, the signal actuates a solenoid 62 or other such device which releases the brakes on the transport means 26, electrical connecting being made through the docking interlock with the x-ray pallet maneuvering mechanism 24. In another embodiment, the circuit 50 initiates a control 64 which blocks the x-ray pallet maneuvering mechanism 24 from moving the pallet to the transport gurney or from undocking the transport gantry until all instruments have been sensed as being present in the tray. In another embodiment, the signal actuates a solenoid or other such device that prevents a door or gate separating the surgical area from the MR area to be opened. Alternately, as illustrated in FIG. 3, the pallet transport means 26 includes guide rails 120 between the x-ray imager 10 and the MRI scanner 12, a drive, such as a chain drive 122 and motor 124. Sensing that all instruments 40 have been returned to the tray 42 releases a brake on the chain drive, closes a relay that supplies power to the drive motor, or otherwise enables the transport means to transfer the pallet past the 5 Gauss line 32 toward the MRI scanner.

With reference to FIG. 4, a means for sensing whether the surgical instruments have been returned to the tray is optical instead of electrical. In the embodiment of FIG. 4, the tray 42 defines wells 70 which are shaped to receive each of its instruments. A light source 72 such as an LED, the discharge end of a fiber optic light guide, or the like is mounted on one side of the well. On an opposite side viewing the light source is an optic fiber 74 with a light receiving end positioned to view the light source. A circuit or means 50′ for determining whether all of the instruments have been returned to the tray includes one or more lumination intensity monitors 50′ which determines whether any of the optic fibers 74 are receiving light from the respective light source. If none are, the intensity monitor means 50′ issues the signal indicating that all instruments have been returned. Alternately, rather than optical fibers, a photosensitive diode or other photodetector can be positioned on an opposite side of the well 70 from the light source to monitor whether the light is visible or whether it is blocked by a received instrument. As another alternative, the light source and the light receiving means may be positioned on the same side of the well in such a manner that the light receiving means receives no light unless an instrument is positioned in the well to reflect light from the light source to the light receiver.

In operation, the patient pallet 22 is mounted on the pallet manipulating mechanism 24 of the x-ray scanner 10. A tray 42 of freshly sterilized surgical instruments are mounted to the support structure 43. One or more x-ray images of the subject is taken and displayed on the monitor 20. Using the display for guidance, a surgical procedure is performed, such as the insertion of an MR compatible catheter, or performing an MR guided brain biopsy. Additional x-ray images are generated during the procedure to assure that the catheter is inserted and positioned properly. However, because magnetic resonance images typically have better soft tissue contrast, the placement of the catheter is typically only an approximation of its final location. The surgical tools are returned to the tray 42 and the transport gantry 26 is docked to the pallet handling mechanism 28. If all of the tools have been returned to the tray, the pallet can be transferred to the transfer pallet and the transport gurney can be undocked. The operator moves the transport gurney with the patient and the pallet toward the 5 Gauss line, noting whether the light 60 is indicating that it is safe to cross the 5 Gauss line. If it is not, another check is made for the surgical instrument that has not been returned to the tray. If the light indicates that it is safe to cross the 5 Gauss line, the transport gantry is docked to the MR pallet manipulating mechanism 28 and the pallet and patient are inserted into the bore of the MRI scanner 10 where an MRI image is generated. The MRI images are used to check an reposition the catheter, as necessary, to position it precisely in a desired location.

The invention has been described with reference to the preferred embodiments. Modifications and alterations will occur to others upon a reading and understanding of the preceding detailed description. It is intended that the invention be construed as including all such modifications and alterations insofar as they come within the scope of the appended claims or the equivalents thereof.

1. An apparatus for inhibiting surgical tools from being brought into proximity with an MRI scanner, the apparatus comprising:
sensing means for sensing whether each of a plurality of surgical instruments has been positioned in a preselected location;
a means for determining whether all surgical instruments have been returned to their preselected locations and issuing a signal indicative thereof.

2. The apparatus according to claim 1, further including:
an optical device responsive to the signal for providing a visual indication whether all instruments have been returned and it is safe to approach the magnetic resonance scanner.

3. The apparatus according to claim 2, wherein the optical device includes a light disposed adjacent a 5 Gauss line which includes a lamp for indicating that it is safe to cross the 5 Gauss line, and a lamp for indicating that it is not safe to cross the 5 Gauss line.

4. The apparatus according to claim 1, wherein the signal at least one of:
releases a brake on a patient transport means for transporting a pallet and an associated patient from an x-ray imager to the magnetic resonance imager;
prevents an interlock from releasing a transport gurney from the x-ray imaging device unless all instruments have been returned;
prevents a pallet manipulating mechanism of the x-ray device from transferring the pallet to the transport gurney; or
prevents a door or gate to an MRI scanner region from opening.

5. The apparatus according to claim 1, wherein the individual instrument sensing means includes at least one of:
clips which hold the instrument in a preselected location with the instrument closing a circuit between the clips;
a clip having a pair of resilient clamping elements which clamp opposite sides of an instrument with the instrument closing a circuit between the two sides of the clip; or
a clip which changes a state of a switch when it receives an instrument.

6. The apparatus according to claim 5, wherein the means for sensing whether all of the instruments have been returned to the preselected location includes:
a power supply for supplying an electrical current to the clips or switches which are connected in series and a circuit for determining whether a closed-loop is formed.

7. The apparatus according to claim 1, wherein the means for sensing whether individual surgical instruments are in their preselected location includes at least one of:
a mechanical element which opens or closes a mechanical switch in response to the presence or absence of an instrument;
a proximity detector;
a capacitive coupling with the instrument; or
an inductive coupling with the instrument.

8. The apparatus according to claim 1, wherein the preselected locations to which the instruments are returned include wells in a tray and the means for determining whether individual instruments have been returned to the preselected location includes:
a light source and a light receiver positioned in the well such that passage of light between the light source and the light receptor is indicative of whether a surgical instrument is in the well.

9. A surgical suite comprising:
a magnetic resonance imaging device;
a pallet for supporting a patient, the pallet being transportable between a surgical position displaced from the magnetic resonance imaging device and the magnetic resonance imaging device by a transport means;
a support for a tray of surgical instruments; and
an apparatus according to claim 1 for determining whether all of the surgical instruments have been returned to preselected locations in the tray.

10. The surgical suite according to claim 9, wherein the means for determining whether each instrument has been returned to the tray are mounted on the tray and the means for determining whether all of the instruments have been returned to the tray are mounted in the suite outside of the tray, and further including an electrical interconnection for interconnecting the individual sensing means and the means for sensing whether all of the instruments have been returned to the tray.

11. The apparatus according to claim 1, further including:
a plurality of trays, each tray being configured for holding the surgical instruments for a specified surgical procedure.

12. The apparatus according to claim 9, further including:
an x-ray device, the transport means transporting the pallet between the x-ray device and the magnetic resonance imaging device.

13. The apparatus according to claim 9, further including:
a pallet manipulating mechanism connected with the x-ray scanner, the transport gurney being dockable with the pallet manipulating mechanism such that the pallet manipulating mechanism can transfer the pallet to the transfer gurney;
the transport gurney including wheels with associated brakes;
the signal being communicated to at least one of the pallet manipulating mechanism and the transport gantry to control whether at least one of:
the transport gantry brakes are releasable,
the transport mechanism can transfer the pallet to the transport gantry, or
the transport gantry can be released from docking engagement with the pallet manipulating mechanism.

14. A method of inhibiting surgical tools from being brought into proximity with an MRI scanner, the method comprising:
determining whether each of a set of medical instruments has been returned to a preselected location;
determining whether all of the medical instruments have been returned to the preselected location.

15. The method according to claim 14, further including:
in response to determining whether all of the instruments have been returned, providing a visual indication which indicates whether it is safe to approach the MR scanner.

16. The method according to claim 14, wherein the step of determining whether each instrument has been returned to the preselected location further includes:
connecting the instruments into an electrical circuit as part of a conductive path.

17. The method according to claim 14, wherein the step of sensing whether each element is in the preselected location includes optically sensing the presence of each instrument.

18. A method of performing a surgical procedure comprising:
positioning a subject on a pallet adjacent an x-ray imager and generating at least one x-ray image;
removing surgical instruments from preselected locations in an instrument tray to perform a surgical procedure on the subject;
returning the surgical instruments to the preselected locations in the surgical tray;
determining whether all of the surgical instruments have been returned to the preselected locations in the tray according to the method of claim 14;
in response to determining that all surgical instruments have been returned, transferring the subject and the pallet from the x-ray imager to a magnetic resonance imaging apparatus.

19. The method according to claim 18, further including:
in response to sensing that all of the non-MRI compatible surgical instruments have been returned to the preselected locations in the tray, providing a visual indication that it is safe to cross a visible demarcation of a minimum safe distance that the non-MRI surgical instruments can safely approach the MRI scanner.

20. The method according to claim 18, further including:
in response to determining that all of the surgical instruments have been returned to the preselected locations in the tray, at least one of:
enabling a pallet manipulating means to transfer the pallet to a transport gantry;
enabling brakes on the transport gurney to be released, or
enabling the transport gurney to be released from the pallet manipulating mechanism.

21. The method according to claim 18, further including:
in response to determining that all of the surgical instruments have not been returned to the preselected locations in the tray, at least one of:
providing a visible indication that it is not safe to move the pallet and subject to the MRI imaging apparatus;
blocking brakes on a transport gurney from being released;
blocking a pallet manipulating mechanism which supports and maneuvers the pallet in the x-ray scanner from transferring the pallet;
blocking a release of the transport gurney from a docketed position abutting the pallet manipulating mechanism; or,
blocking a transfer drive from moving the pallet from the x-ray scanner to the MRI imaging apparatus.
